(19) United States
(12) Patent Application Publication
(10) Pub. No.: US 2021/0326713 A1
(43) Pub. Date: Oct. 21, 2021

(54) WORD POLARITY A MODEL FOR INFERRING LOGIC FROM SENTENCES

(71) Applicant: Michelle N Archuleta, Lakewood, CO (US)

(72) Inventor: Michelle N Archuleta, Lakewood, CO (US)

(21) Appl. No.: 17/277,314

(22) PCT Filed: Sep. 24, 2019
(86) PCT No.: PCT/US19/52547

§ 371 Date: Mar. 18, 2021

Related U.S. Application Data
(60) Provisional application No. 62/735,600, filed on Sep. 24, 2018.

(51) Int. Cl. G06N 5/00; G06F 40/35; G06F 40/247; G06N 3/08

(52) U.S. Cl. CPC G06N 5/006; G06N 3/08; G06F 40/247; G06F 40/35

(57) ABSTRACT

Methods, systems, and apparatus, including computer programs language encoded on a computer storage medium for a word-to-logic system whereby input text is used to extract the symmetry of word relationships, quantify symmetry, and negate symmetrical relationships into logical equations evaluate logical equation using an automated theorem prover and return the logical state of the input text. A real-time logic engine utilizes the derived logical equations as a set of ‘a priori’ assumptions such that a user can query the system and receive an output that indicates the logical state of the query.

### RELATED APPLICATIONS

This application claims priority to U.S. Provisional Patent Application No. 62/735,600 entitled “Reinforcement learning approach using a mental map to assess the logical context of sentences” Filed Sep. 24, 2018, the entirety of which is hereby incorporated by reference.

### TECHNICAL FIELD

The present invention relates generally to Artificial Intelligence related to logic, language, and network topology. In particular, the present invention is directed to word relationship, network symmetry, word polarity, and formal logic derived for identifying logical errors in technical documents and is related to classical approaches in natural language processing and set theory. In particular, it relates to deriving word relationships into executable logical equations.

### BACKGROUND ART

Medical errors are a leading cause of death in the United States (Wittich C M, Burkle C M, Lanier W L. Medication errors: an overview for clinicians. Mayo Clin. Proc. 2014 August; 89(8):1116-25). Each year, in the United States alone, 7,000 to 9,000 people die as a result of medication errors (Id. at pg. 1116). The total cost of caring for patients with medication-associated errors exceeds $40 billion dollars each year (Whittaker C F, Miklich M A, Patel R S, Fink J C. Medication Safety Principles and Practice in CKD. Clin J Am Soc Nephrol. 2018 Nov. 7; 13(11):1738-1746). Medication errors compound an underlying lack of trust between patients and the healthcare system.

Medical errors can occur at many steps in patient care, from writing down the medication, dictating into an electronic health record (EHR) system, making erroneous amendments or omissions, and finally to the time when the patient administers the drug. Medication errors are most common at the ordering or prescribing stage. A healthcare provider makes mistakes by writing the wrong medication, wrong route or dose, or the wrong frequency. Almost 50% of medication errors are related to medication-ordering errors. (Tariq R, Scherbak Y., Medication Errors StatPearls 2019; Apr. 28)

The major causes of medication errors are distractions, distortions, and illegible writing. Nearly 75% of medication errors are attributed to distractions. Physicians have ever increasing pressure to see more and more patients and take on additional responsibilities. Despite an ever-increasing workload and oftentimes working in a rushed state a physician must write drug orders and prescriptions. (Tariq R, Scherbak Y., Medication Errors StatPearls 2019; Apr. 28)

Distortions are another major cause of medication errors and can be attributed to misunderstood symbols, use of abbreviations, or improper translation. Illegible writing of prescriptions by a physician leads to major medication mistakes with nurses and pharmacists. Often times a practitioner or the pharmacist is not able to read the order and makes their best guess.

The unmet need is to identifying logical medication errors and immediately inform healthcare workers. There are no solutions in the prior art that could fulfill the unmet need of identifying logical medication errors and immediately informing healthcare workers. The prior art is limited by software programs that require human input and human decision points, supervised machine learning algorithms that require massive amounts (10⁹-10¹⁰) of human generated paired labeled training datasets, and algorithms that are brittle and unable to perform well on datasets that were not present during training.

### SUMMARY

This specification describes a word-to-logic system that includes a methodology to extract the symmetry of word relationships, quantify symmetry, and negate symmetrical relationships into logical equations which is implemented as computer programs one or more computers in one or more locations. The word-to-logic system components include input data, computer hardware, computer software, and output data that can be viewed by a hardware display media or paper. A hardware display media may include a hardware display screen on a device (computer, tablet, mobile phone), projector, and other types of display media.

Generally, the system transforms words in text into logical equations by constructing a network of word relationships from the text, identifying symmetry within the network, quantifying symmetry between nodes in the network, and negating the symmetry into a set of relationships, and formalizing those relationships into formal logic. An automated theorem prover to assess logical validity can evaluate the formal logic. The formal logic from text can be evaluated in a real-time logic engine such that a user inputs text and receives a return message indicating whether or not the text was logical. Alternatively a user can provide a high quality peer-reviewed text such that the text is transformed into a set of logical equations to be used as an ‘a priori’ knowledge base and a query statement to be evaluated against the knowledge database.

The real-time logic engine transforms text into a set of logical equations, categorizes the equations into assumptions and conclusion whereby the automated theorem prover using the assumptions infers a proof whereby the conclusion is logical or not. The real-time logic engine has the ability to transform a query statement into a set of assumptions and conclusion by executing the following instruction set on a processor: 1) a word network is constructed using the discourse and ‘a priori’ word groups, such that the word network is composed of node-edges defining word relationships; 2) ‘word polarity’ scores are computed to define nodes of symmetry; 3) a set of negation relationship are generated using the word network, antonyms, and word polarity scores; 4) a set of logical equations is generated using an automated theorem prover type, negated relationships, word network, and query statement.

In some aspects the text and groups are used to construct a network whereby a group of words is used as the edges and another group of words is used as the nodes The groups could include any possible groups of words, characters, punctuation, properties and/or attributes of the sentences or words.

In some aspects a word embedding vector space could be substituted for a word network. In such implementations symmetrical relationships would be derived from the word embedding vector space.

In some aspects, the word polarity score is defined between two nodes in the network whereby the nodes have symmetrical relation with respect to each other such that the nodes share common connecting nodes and/or antonym nodes.

In some aspects, either the network, antonyms, and/or the polarity score are used to create negated relationships among nodes in the network.

In some aspects the negated relationships are formulated as a formal propositional logic whereby an automated propositional logic theorem prover evaluates the propositional logic equations and returns a positive reward if the discourse is logical and a negative reward if the discourse is nonsensical.

In some aspects the negated relationships are formulated as a formal first-order logic whereby an automated first-order logic theorem prover evaluates the first-order logic equations and returns a positive reward if the discourse is logical and a negative reward if the discourse is nonsensical.

In some aspects the negated relationships are formulated as a formal second-order logic whereby an automated second-order logic theorem prover evaluates the second-order logic equations and returns a positive reward if the discourse is logical and a negative reward if the discourse is nonsensical.

In some aspects the negated relationships are formulated as a formal higher-order logic whereby an automated higher-order logic theorem prover evaluates the higher-order logic equations and returns a positive reward if the discourse is logical and a negative reward if the discourse is nonsensical.

In some aspects a user may provide a set of logical equations that contain a specific formal logic to be used as assumptions in the real-time logic engine. In another embodiment a user may provide a set of logical equations that contain a specific formal logic to be used as the conclusion in the real-time logic engine. In another embodiment a user may provide the logical equations categorized into assumptions and conclusions.

### BRIEF DESCRIPTION OF THE DRAWINGS

FIG. 1 illustrates a word-to-logic system with the following components: input from user, hardware, software, and output.

FIG. 2 illustrates a word-to-logic extraction system, logic rule builder, and logic proof engine stored, executed, and displayed with hardware interfaces.

FIGS. 3A & 3B illustrates an example of creating a word network from a sentence.

FIGS. 4A & 4B illustrates word networks arranged on a word polarity scale.

FIGS. 5A, 5B, & 5C illustrates word symmetry used generate negation relationships and logical form equations.

FIGS. 6A & 6B flow diagram for deriving symbolic word relations using word polarity from a word network.

### DETAILED DESCRIPTION

### Word-To-Logic System

The specification describes a word-to-logic system whereby a corpus of input data is provided by an individual or individuals(s) or system into a computer hardware whereby data sources and the input corpus are stored on a storage medium and then the data sources and input corpus are used as input to a computer program or computer programs which when executed by a processor or processors generates a logical proof engine. The logic proof engine is a computer program that resides on memory or alternatively on a network. An individual or individuals interface with the logical proof engine by typing a sentence using a keyboard or audio speaker such that an audio signal is further transformed into text through an audio voice recognition system. The logical proof engine resides on memory, receives an input sentence and is executed by a processor resulting in an output notification through a hardware display screen that informs an individual or individuals whether or not the input sentence is logical or not.

The logical proof engine residing in memory is able to evaluate text to determine if the text is logically correct based on a set of logically formulated rules whereby a logic rule builder constructs logically formulated rules from a peer-reviewed input data source. The logic rule builder residing on memory and when executed by a processor extracts sentences, maps word relationships to a network, detects symmetry within the word network, calculates a word polarity score, and builds out a set of logical equations that describes the symmetry of the word network.

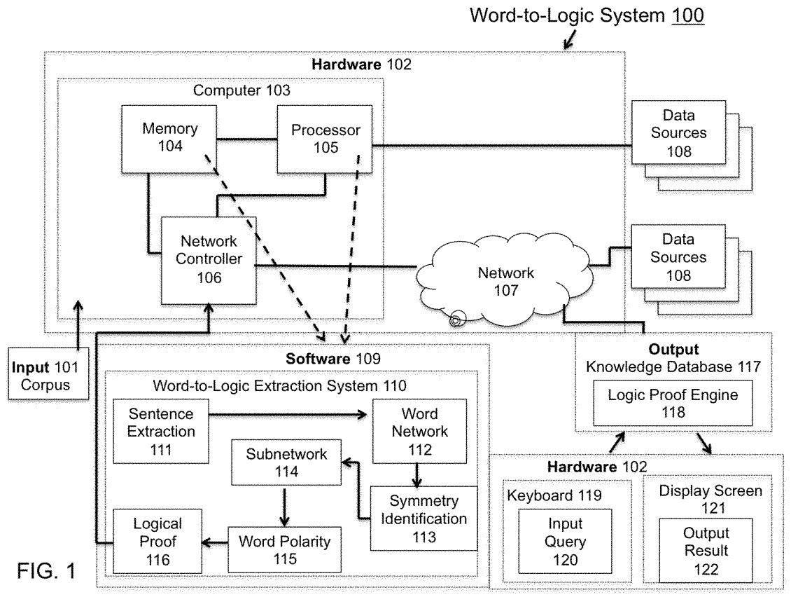

FIG. 1 illustrates the word-to-logic extraction system 100 with the following components: input 101, hardware 102, software 109, and output 116. The input is a peer-reviewed corpus of content such as a medical journal, technical report, legal document, and technical content, among others. The input 101 may be provided by an individual, individuals or a system and entered into a hardware device 102 such as a computer 103 with a memory 104, processor 105 and or network controller 106. A hardware device is able to access data sources 108 via internal storage or through the network controller 106, which connects to a network 107.

The data sources 108 that are retrieved by a hardware device 102 in one of other possible embodiments includes for example but not limited to: 1) an antonym and synonym database, 2) a thesaurus, 3) a corpus of co-occurrence words, 4) a corpus of word-embeddings, and 5) a corpus of part-of-speech tags.

The data sources 108 and the peer-reviewed input corpus 101 are stored in memory or a memory unit 104 and passed to a software 109 such as computer program or computer programs that executes the instruction set on a processor 105. The software 109 being a computer program executes a word-to-logic extraction system 110 whereby sentences are extracted from the input corpus 101 and used to create a word network 112. A symmetry identification 113 software being a computer program receives the word network 112 residing in memory 104 and executes the instruction set on a processor 105 and outputs node indices of network symmetry based on a user set threshold. A word polarity 114 software takes as input the node indices of network symmetry residing in memory 104 executes the instruction set on a processor 105 and outputs a word polarity score for each word in the word network 112 whereby each indices of network symmetry correspondence to a subnetwork 115 in the word network 112. A logic rule builder residing on memory takes as input the word polarity scores and a user defined word polarity threshold executes the instruction set on a processor 105 and outputs a set of symbolical logical rules that together compose a logical proof 116.

The logical proof 116 is received by a network controller 106 passed to a network 107 where it resides as a component of the final output of a knowledge database 117. The knowledge database 117 when queried by an individual or individuals through a hardware device executes the logic proof engine 118 software as an instruction set on a processor 105 and stores in a database that resides on a memory 104 the input query and the output value from execution of the logic proof engine 118. The knowledge database 117 returns the final output value to an individual or individuals.

A user queries the knowledge database 117 by interacting with a hardware device 102, a keyboard 119, and typing or ‘copy & paste’ the input query 120 into the knowledge database 117. The final output value 122 upon execution of the logic proof engine 118 instruction set on a processor is delivered to an individual or individuals through a hardware 102 display screen 121.

### Word-to-Logic Extraction System

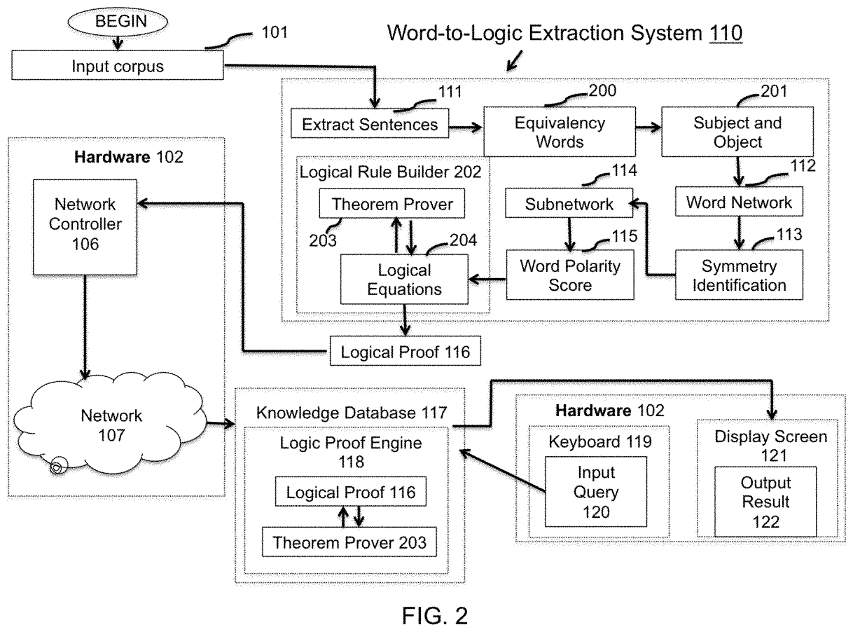

FIG. 2 provides further detail on the word-to-logic extraction system 110. A word network builder computer program extracts sentences 111 from the input corpus 101 residing in memory and identifies a set of equivalency words 200. An example of English equivalency words includes ‘is’, ‘are’, and ‘also known as’ among others. The subject and object 201 of the sentence are also identified when the word network builder computer program executes the instruction set on a processor 105. The word network 112 is constructed from the subject and object 201 of the extracted sentences, whereby a node of the network maybe either the subject or object and the edge between the nodes represents the relationship as established by the equivalency words 200. Other embodiments include building a word network for any combination of word relationships defined as edges and/or nodes.

The symmetry identification 113 computer program identifies geometric symmetry within the word network 112; saving each location of geometric symmetry as a subnetwork 115. A word polarity score 114 is computed for each node that was identified as symmetrical. A user defined word polarity threshold is used as a cutoff threshold whereby symbolic logical equations 204 that describe a node and a symmetrical relationship with another node are generated for all words in the network that have a word polarity score greater than the user defined word polarity score. The logic rule builder generates a set of logical equations 204 for each symmetry identified in the network with nodes that have word polarity score that is greater than the user defined threshold. The logical equations are generated 204 and then tested against a theorem prover computer program 203. Prospective embodiments of theorem provers may include but are not limited to the following: Prover9, Bliksem, Mace4, SPASS, LangPro, E Prover, Holophrase, BareProver, Metamath, IPL, SAT, XGBoost predictor, Coq interpreter, and Otter Prover.

The set of logical equations that return a Boolean value of True by a theorem prover computer program 203 are saved as a logical proof 116 for each subnetwork 115 in the word network 112. The logical proof 116 and theorem prover 203 reside on memory as part of a knowledge database 117. When the knowledge database 117 is queried by a user interacting with a hardware device 102, such as a keyboard 119, the knowledge database executes the logic proof engine 118 software as an instruction set on a processor such that the logic proof engine 118 evaluates the logical validity of the input query 120.

### Word Network

A word network builder system performs steps 111, 200, 201, & 112 in FIG. 2 with the following components: input 101, hardware 102, software 109, and output 116. The word network builder system requires an input corpus 101 of peer-reviewed content, a hardware 102 consisting of a memory 104 and a processor 105, a software 109 word network builder computer program, and an output word network 112 residing in memory. A word network builder system can be configured with user specified data sources 108 to construct a word network 112 with any combination of word relationships represented as edges or/and nodes.

The word network 112 is a graphical representation of the relationships between words represented as nodes and relationship between words are edges. Nodes and edges can be used to represent any or a combination of parts-of-speech tags or word groups in a sentence. An embodiment of a word network may include extracting the subject and object from a sentence such that the subject and object are the nodes in the network and the verb or adjective is represented as the edge of the network. Another embodiment may extract verbs as the nodes and subjects and/or objects as the edges. Additional combination of words and a priori categorization of word relationships are within the scope of this specification for constructing a word network 112.

An advantage of representing sentences in a word network are the following: 1) ability to simplify sentences into word relationships; 2) identify symmetry in word relationships; 3) easily extract all symmetrical relationships between nodes in the network; and 4) easily extract node and edges to build out logic rules. These and other benefits of one or more aspects will become apparent from consideration of the ensuing description.

The following steps provide an example of how a word network could be constructed for a Wikipedia medical page such that an input 101 of the first five sentences of Wikipedia medical page is provided to the system and an output of the medical word network 112 is produced from the system. The first step, the input corpus 101 is defined as Wikipedia medical page 102 and the first five sentences are extracted from the input corpus 101. The second step, a list of English equivalency words is defined. In this embodiment the English equivalency words are the following ‘is’, ‘are’, ‘also referred as’, ‘better known as’, ‘also called’, ‘another name’ and ‘also known as’ among others. The third step, filter the extracted sentences to a list of sentences that contain an English equivalency word or word phrase. The fourth step, apply a part-of-speech classifier to each sentence in the filtered list. The fifth step, group noun phrases together. The sixth step, identify and label each word as a subject, objective, or null. The seventh step, create a mapping of subject, verb, object to preserve the relationship. The eighth step, remove any words in the sentence that are not a noun or adjective, creating a filtered list of tuples (subject, object) and a corresponding mapped ID 303. The ninth step, identify and label whether or not a word in the tuple (subject, object) exist in the network. The tenth step, for tuples that do not exist in the network add a node for the subject and object, the mapped ID 30 for the edge, and append to the word network 112. The eleventh step, for tuples that contain one word that does exist in the network, add the mapped ID 303 for the edge, and the remaining word that does not exist in the word network as a connecting node. The twelfth step, for tuples that exist in the network pull the edge with a list of mapped IDs if the mapped ID 303 corresponding to the tuple does not exist append the mapped ID 303 to the list of mapped IDs 303 that correspond with the edge otherwise continue.

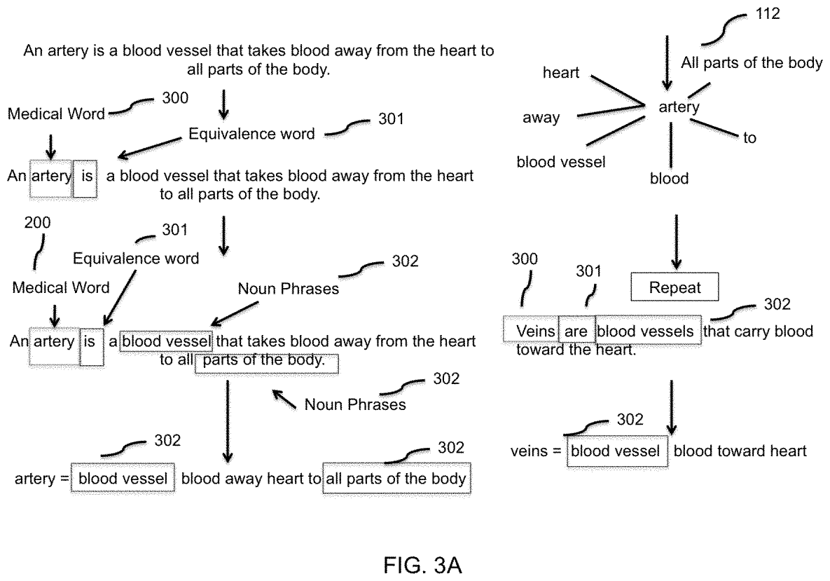

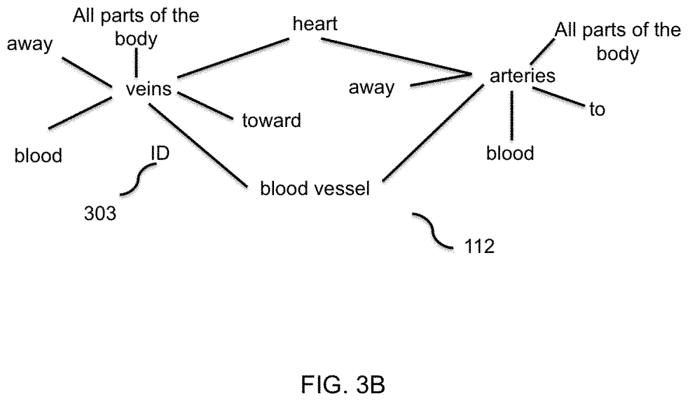

FIG. 3A & 3B shows how a medical sentence is turned into a medical word network. A medical word 300 is defined by first identifying an English equivalence word 301, which in this example is the word ‘is’. Noun phrases 302 within the sentence are grouped together. Then the medical word 300 is equated to the words on the right side of the equivalence word. All words that are not noun or adjective are removed from the sentences except for words that are part of the grouped noun phrases 302. A word network 112 is constructed for the word ‘artery’. The same process is repeated for the word ‘veins’. The resulting word network 112 that connects nodes between the medical words 200 ‘veins’ and ‘arteries’ is shown in FIG. 3B.

In some embodiments a word embedding vector space is used instead of the word network. Word embedding is a set of language modeling and feature learning techniques in natural language processing where words or phrases from the vocabulary are mapped to vectors of real numbers. Word embeddings involves a mathematical embedding from a space with many dimensions per word to a continuous vector space with a much lower dimension.

### Symmetry Identification

A symmetry identification system performs steps 113 & 114 with the following components: input 101, hardware 102, software 109, and output 113. The symmetry identification system requires an input word network 112, a hardware 102 consisting of a memory 104 and a processor 105, a software 109 symmetry identification computer program, and output subnetworks 114 and symmetry identification scores 113 residing in memory. A symmetry identification system can be configured with user specified data sources 108 to identify word network 112 symmetry at different levels of certainty. A symmetry identification system can be configured with user specified data sources 108 to use an ensemble of symmetry identification methods or a specific symmetry identification method.

In some implementations a symmetry identification computer program, defines symmetry using the Purchase Measure, whereby only reflective symmetry is considered. The Purchase Measure computes an axis of potential symmetry between every pair of the graph vertices whereby each axis, a symmetrical subgraph, consisting of all the edges that are indicent on vertices mirrored across the axis within a predefined tolerance is computed. The convex hull area is computed for each subgraph. A final symmetry score is a ratio of the sums of the values for all nontrivial axes. The Purchase Measure is designed to capture both ‘local’ and ‘global’ symmetries (Purchase H. C.: Metrics for graph drawing aesthetics. Journal of Visual Languages & Computing 13, 5 (2002), 501-516.).

Symmetry refers to any manner, in which part of a pattern can be mapped onto another part of itself. Metrics for measuring symmetry include translational symmetry, rotational symmetry, and reflectional symmetry. Translational symmetry is the invariance of the network to transformations that are applied. Rotational symmetry is the property a network has to remain the same after some rotation by a partial turn. Reflectional symmetry is symmetry with respect to a reflection whereby the network does not change upon undergoing a reflection. This specification includes any combination of metrics or a single metric to measure and/or identify locations of symmetry within the word network 112.

In some implementations a symmetry identification computer program, defines symmetry using the Klapaukh Measure, whereby reflection, rotation, and translation symmetries are measured. The Klapaukh Measure encodes edges as scale-invariant feature transform (SIFT) features, and uses each edge and each pair of edges to generate potential symmetry axes. A quality score is computed for each symmetrical axis based on how well the edges map onto one another with respect to their lengths and orientation. All axes are quantized such that similar axes are taken as a single axis. A summation of all quality scores for the axes that were combined is used to determine the best N axes. The final symmetry score is a normalized sum, over the best N axes of the number of edges that vote for each axis (Klapaukh R.: An Empirical Evaluation of Force-Directed Graph Layout. PhD thesis, Victoria University of Wellington, 2014).

In some implementations a symmetry identification computer program, defines symmetry using the Stress minimization method, whereby the objective is to minimize suitably-defined energy functions of the graph. ‘Stress’ is defined as the variance of edge lengths. A graph G=(V, E) has positions pᵢ such that pᵢ is the position of vertex i∈V. The distance between two vertices i,j∈V is denoted by ∥pᵢ−pⱼ∥. The energy of the graph is measured by Σ_{i,j∈V}wᵢⱼ(∥pᵢ−pⱼ∥−dᵢⱼ)² where dᵢⱼ is the ideal distance between vertices i and j and wᵢⱼ is a weight factor. The algorithm is then optimized to identify the lower stress values that correspond to a better graph (Gansner E., Koren Y., North S.: Graph drawing by stress majorization. In Graph Drawing, Pach J., (Ed.), vol. 3383 of LNCS. Springer, 2005, pp. 239-250). The ‘Stress’ method is implemented on randomly seeded regions throughout the word network 112 to identify minimal energy subnetworks 115.

In some implementations a symmetry identification computer program, defines symmetry using a Convolutional Neural Network (CNNs), whereby filters reside on layers, where higher layers extract more abstract features of the word network 112. The architecture of the CNN includes: 1) convolutional layers, such that the output of a previous layer is convolved with a set of different filters; 2) pooling layers in which subsampling of the previous layer is performed by taking the maximum over equally sized subregions; 3) normalization layers that perform local brightness normalization. The CNN architecture with several fully connected layers that are stacked on top of a network, is able to learn to map extracted features onto class labels (Brachmann A., Redies C.: Using Convolutional Neural Network Filters to Measure Left-Right Mirror Symmetry in Images. Symmetry, vol. 8 of MDPI, 2016, pp. 2-10). The CNN algorithm is trained on paired image symmetry training datasets. The CNN algorithm is implemented on randomly seeded regions throughout the word network 112 to identify subnetworks 115. The CNN algorithm measures a reflectional symmetry at each of the seeded regions whereby the asymmetry of the max-pooling layer is calculated for right and left mirror symmetry.

In some implementations an unsupervised clustering algorithm is used to identify clusters, or subnetworks 114 within the word network 112. The clusters identified by unsupervised clustering algorithms are used to seed the location of the word network before applying the symmetry identification computer program. Symmetry identification computer programs which may include but not limited the previously mentioned computer programs can then used to compute symmetry scores for each subnetwork 114.

### Word Polarity

A word polarity system performs step 115 with the following components: input 101, hardware 102, software 109, and output 116. The word polarity system requires an input word network 112, subnetworks 114, and symmetry identifications scores 113, a hardware 102 consisting of a memory 104 and a processor 105, a software 109 word polarity computer program, and output word polarity scores 115 residing in memory. The word polarity system can be configured with user specified data sources 108 to return nodes in the word network 112 that are above a word polarity threshold score. The word polarity identification system can be configured with user specified data sources 108 to use an ensemble of word polarity scoring methods or a specific word polarity scoring method.

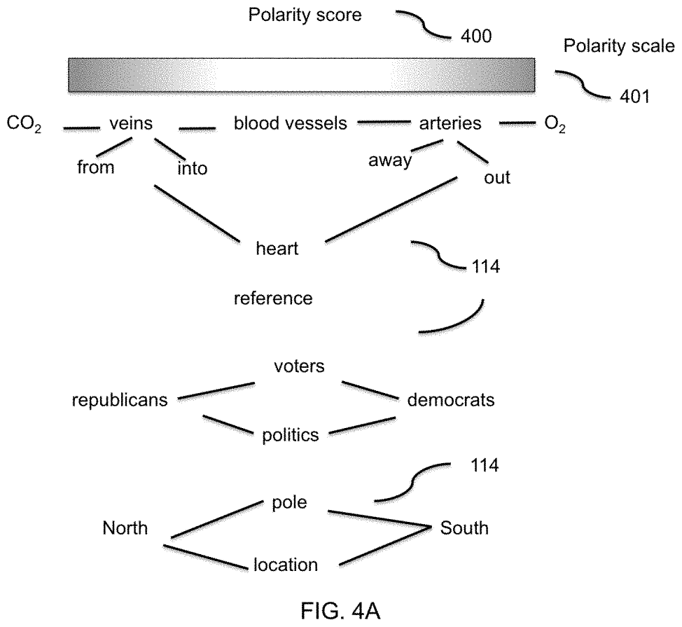

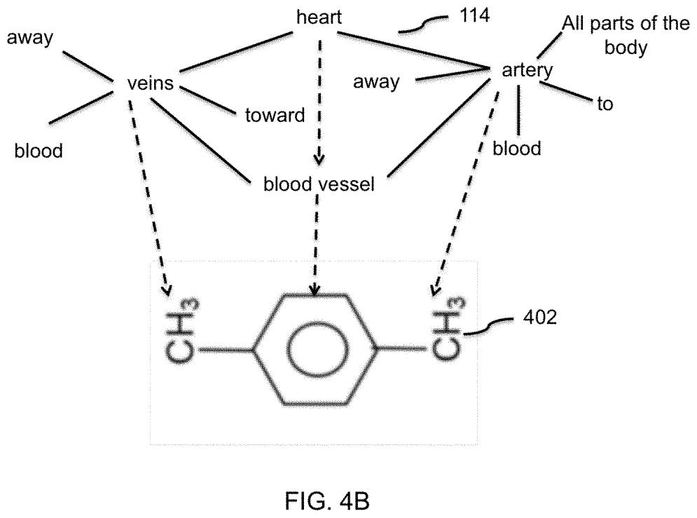

FIG. 4A shows three examples of ‘polar’ words that can be identified from the word network 114. In this first network the words with the highest polarity scores, 400 as defined by the polarity scale 401 are the words ‘veins’ and ‘arteries’. The words ‘veins’ and ‘arteries’ are symmetrical indicating that they are polar opposites. Arteries being defined as ‘blood vessels that carry oxygenated blood (02) away from the heart’ which is symmetrical in meaning with veins, defined as ‘blood vessels that carry deoxygenated blood to the heart’. The word ‘arteries’ and ‘veins’ are symmetrical in other aspects consider these definitions: ‘Arteries bring oxygen rich blood to all other parts of the body.’ and ‘Veins carry carbon dioxide rich blood away from the rest of the body.’ Polar words have reference words in common for the example of ‘arteries’ and ‘veins’ the shared reference words are ‘blood vessels’ and ‘heart’. They also have antonym words shared between them such as ‘carry out’ (arteries) and ‘carry into’ (veins), ‘oxygenated blood O₂ (arteries)’ and ‘deoxygenated blood CO₂ (veins)’, and ‘carry blood to the body (arteries)’ and ‘carry blood away from the body (veins)’.

Similar words that are symmetrical include ‘Republicans’ and ‘Democrats’ (FIG. 4A), ‘North’ and ‘South’ (FIG. 4A.) The reference words for ‘Republicans’ and ‘Democrats’ are ‘voters’, ‘politics’, ‘convention’, ‘primary’, etc. among others and reference words for ‘North’ and ‘South are ‘pole’, ‘location’, ‘map’ etc. Symmetrical words are similar in size in terms of the number of nodes that they are connected to.

Neutral words with low word polarity scores are words such as ‘blood vessels’, ‘heart’, and ‘location’. The word ‘heart’ in relation to medicine has no ‘polar word’ that has opposite and relating functions and attributes. However, outside of medicine in literature for example the word ‘heart’ may have a different polarity score perhaps ‘heart’ relates to ‘love’ vs. ‘hate’. The polarity scores of words can change depending on their underlying corpus.

An analogy to a ‘polar’ word can be taken from Chemistry with special isomers, enantiomers. Enantiomers are optical isomers with two stereoisomers that are reflections or mirror images of one another. FIG. 4B depicts a Benzene isomer in which the two side chains of a Benzene ring are mirror images of each other. This relates to ‘polar’ words, which reflect each other around a common shared ‘Benzene axis’ in this case, words such as ‘heart’ and ‘blood vessel’. Polar words have a very symmetrical structure similar to enantiomers. The polar structure of words infers relationships both within a knowledge base and within the context of a particular text.

In some implementations the word polarity computer program, computes a word polarity score 115 for each node in relation to another node in the subnetwork 114. The polarity score 115 is calculated based on shared reference nodes N_{ref} and shared antonym nodes N_{An}. The node polarity connections are defined as N_{polarity}=wₛN_{Ref}+w_{A}N_{Ant}. A global maximum polarity score is Max_{polarity}=max(N_{polarity}) is computed across all subnetworks 114. The word polarity score 115 is computed as P_{score}=N_{polarity}/Max_{polarity} with respect to each node Nᵢ interacting with node Nⱼ.

In some implementations the word polarity computer program, computes a word polarity score 115 by identifying the axis with the largest number of symmetrical nodes within each subnetwork 114. The summation of nodes along the axis that maximizes symmetry defines a node polarity connection score N_{polarity}=Σ_{i,j∈S}_{ₖ}n_{i,j} such that i,j represent nodes in relation to each other in the subnetwork Sₖ computed for all subnetworks 114 in the word network 112. A global maximum polarity score is Max_{polarity}=max(N_{polarity}) is computed across all subnetworks 114. The word polarity score 115 is computed as P_{score}=N_{polarity}/Max_{polarity} with respect to each node Nᵢ interacting with node Nⱼ.

### Logical Rule Builder

A logical rule builder system performs step 116 with the following components: input 101, hardware 102, software 109 (theorem prover 203 and logical equations 204), and output 116. The logical rule builder system requires input subnetworks 114 above a user configured word polarity score 115, a hardware 102 consisting of a memory 104 and a processor 105, a software 109 theorem prover 203 computer program and logical equations 204 computer program, and output logical proof equations 116 residing in memory. The logical rule builder system can be configured with user specified data sources 108 to return logical proof equations 116 based on the word polarity threshold score. The logical rule builder system can be configured with user specified data sources 108 to use a theorem prover from a selection of theorem provers or to import an additional theorem prover or theorem provers. The logical rule builder system can be configured with user specified data sources 108 to import user specified logical rule or logical rules.

The logical rule builder system residing in memory and when executed on a processor calls the logical equations 204 computer program passing as arguments the subnetworks 114 above a user configured word polarity score 115 and the theorem prover type. The logical equations 204 computer program when executed as an instruction set on a processor extracts the nodes with the maximum word polarity score in each subnetwork 114 and generates logical relationships negating the polar nodes of the network and the node-to-node relationship that are reflective around the symmetrical axis. The mapping ID or IDs 303 that correspond to each edge in the subnetwork 114 are then used to extract the original sentence or original sentences used to derive the node-to-node relationship in the subnetwork 114.

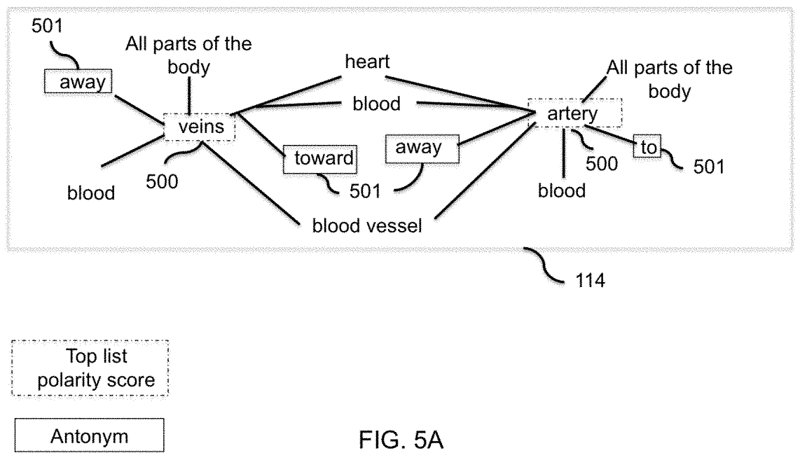

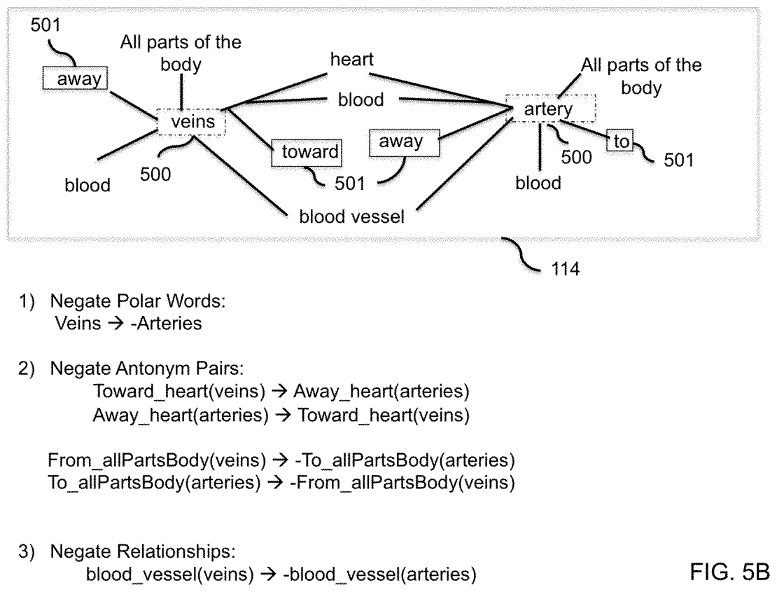

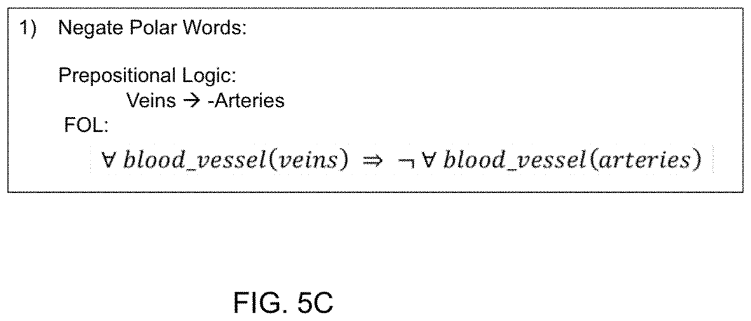

FIGS. 5A, 5B, & 5C illustrates the steps for generating logical relationships that are then formulated into logical proof 116 using as input the word polarity scores 115, subnetworks 114, and antonyms 501. FIG. 5A shows a subnetwork 114 in which the nodes in the top list of word polarity scores 500 are shown in the dashed boxes and the antonyms 501 are shown in the solid boxes. The steps for generating logical relationships 116 from the subnetwork 114 are shown in FIG. 5B. The steps are the following: 1) negate polar words, 2) negate antonym pairs, 3) negate relationships. FIG. 5C shows an example of extracting semantics from the sentences of the new discourse 202 and/or subnetwork 114 in a formal language and thus generating logical equations 301.

FIG. 5C shows the example of negating the polar words and outputting propositional logic and FOL. It should be noted that someone skilled in the art is able to transform English sentences into a formal language of logic. The symmetry extraction method transforms the English sentences into a formal language of logic as shown in FIG. 5C whereby a set of rules maps English sentences into formal languages. It may not be possible to transform some sentences and word network relationships into types of logic (e.g. HOL) and/or any logical form. If it is not possible to transform some sentences into a logical form the following steps will be performed: 1) automatically changing the automated theorem prover and deriving the set of logical equations for that theorem prover until all options are exhausted; 2) returning an error and/or logging the error.

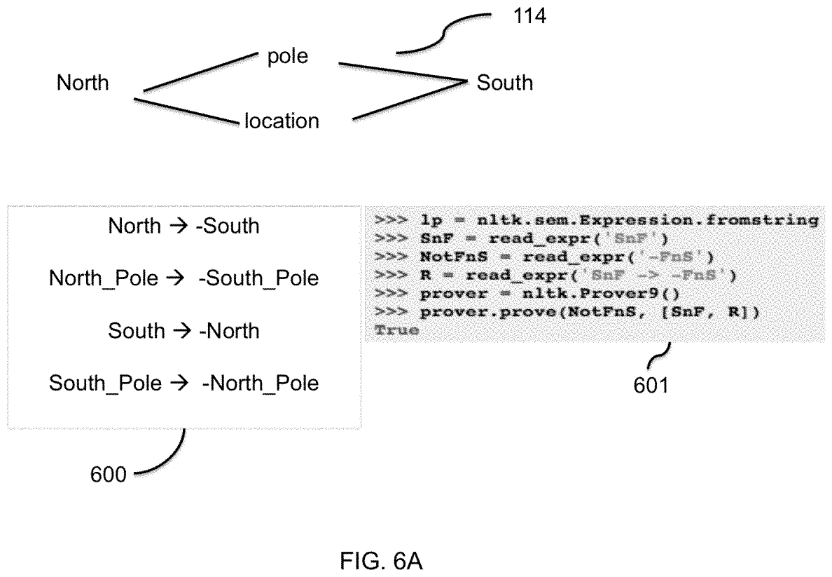

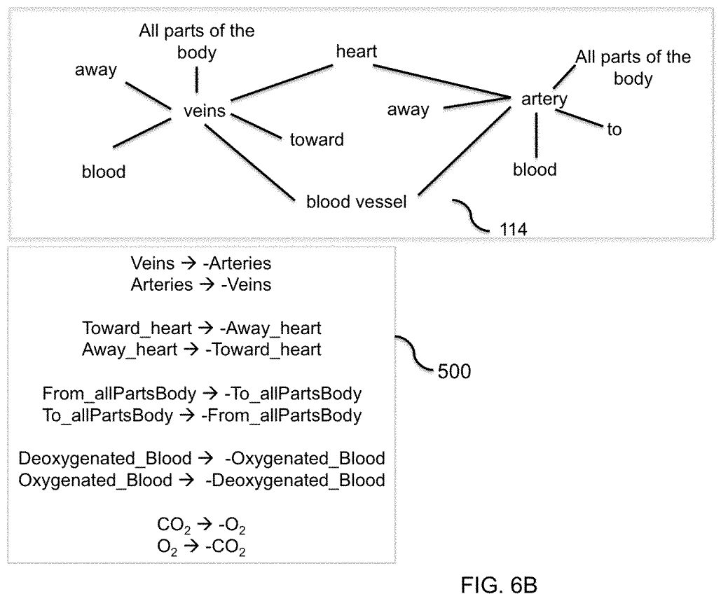

FIG. 6A shows an example embodiment utilizing an automated theorem prover derived from first-order and equational logic whereby a subnetwork 114 with symmetry between node nᵢ ‘North’ and neighboring node n_{j∈N} ‘South’ with shared reference nodes N_{Ref} ‘pole’ and ‘location’. A list of logical statements can be derived from the subnetwork 114, such as North→-South, North_pole→-South_pole, South→-North, South_pole→-North_Pole as shown in 600. These statements can be evaluated using python's nltk prover9 601.

The benefits of this embodiment include being able to evaluate a node using its node polarity score P_{score} and when the node polarity score is above a user defined threshold derive a set of logical equation that govern the node's relationships to it's polar neighboring node n_{j∈N}. Driving logical equations a group of sentences can be evaluated for their logical correctness. For example, ‘The North pole is to the North.’ and the ‘The South pole is to the South.’ would evaluate to True, while ‘The North pole is to the North.’ and the ‘The South pole is to the North.’ would evaluate to False.

FIG. 6B shows the symmetric relationship in the network between polar nodes ‘veins’ and ‘arteries’ such that shared reference nodes include ‘heart’ and ‘blood vessels’ and antonym nodes ‘away’ (relating arteries to the heart) and ‘to’ (relating veins to the heart) and ‘to’ (relating arteries to other parts of the body) and ‘away’ (relating veins to other parts of the body). From these set of nodes a set of logic statements are derived 500 relating ‘veins→-arteries’, ‘arteries→-veins’, ‘toward_heart→-away heart’, ‘From_allPartsBody→To_allPartsBody’, ‘Deoxygenated_blood→-Oxygenated_blood’, ‘Oxygenated_blood→-Deoxygenated Blood’, ‘CO₂→-O₂’, and ‘O₂→-CO₂’. From these equations a set of sentences for example ‘Veins takes blood to the heart’ and ‘Arteries takes blood to the heart’ would evaluate to False indicating the set of sentences are nonsensical. The benefits of this embodiment include being able to evaluate medical prescriptions in real-time and determine if there were any mistakes.

### Theorem Prover

In some implementations a theorem prover computer program, evaluates symbolic logic using an automated theorem prover derived from first-order and equational logic. Prover9 is an example of a first-order and equational logic automated theorem prover (W. McCune, “Prover9 and Mace4”, http://www.cs.unm.edu/˜mccune/Prover9, 2005-2010.).

In some implementations a theorem prover computer program, evaluates symbolic logic using a resolution based theorem prover. The Bliksem prover, a resolution based theorem prover, optimizes subsumption algorithms and indexing techniques. The Bliksem prover provides many different transformations to clausal normal form and resolution decision procedures (Hans de Nivelle. A resolution decision procedure for the guarded fragment. Proceedings of the 15^{th} Conference on Automated Deduction, number 1421 in LNAI, Lindau, Germany, 1998).

In some implementations a theorem prover computer program, evaluates symbolic logic using a first-order logic (FOL) with equality. The following are examples of a first-order logic theorem prover: SPASS (Weidenbach, C; Dimova, D; Fietzke, A; Kumar, R; Suda, M; Wischnewski, P 2009, “SPASS Version 3.5”, CADE-22: 22nd International Conference on Automated Deduction, Springer, pp. 140-145.), and E theorem prover (Schulz, Stephan (2002). “E—A Brainiac Theorem Prover”Journal of AI Communications. 15 (2/3): 111-126.).

In some implementations a theorem prover computer program, evaluates symbolic logic using an analytic tableau method. LangPro is an example analytic tableau method designed for natural logic. LangPro derives the logical forms from syntactic trees, such as Combinatory Categorical Grammar derivation trees. (Abzianidze L., LANGPRO: Natural Language Theorem Prover 2017 In Proceedings of the 2017 Conference on Empirical Methods in Natural Language Processing: System Demonstrations, pages 115-120).

In some implementations a theorem prover computer program, evaluates symbolic logic using the reinforcement learning based approach. The Bare Prover optimizes a reinforcement learning agent over previous proof attempts (Kaliszyk C., Urban J., Michalewski H., and Olsak M. Reinforcement learning of theorem proving. arXiv preprint arXiv:1805.07563, 2018). The Learned Prover uses efficient heuristics for automated reasoning using reinforcement learning (Gil Lederman, Markus N Rabe, and Sanjit A Seshia. Learning heuristics for automated reasoning through deep reinforcement learning. arXiv:1807.08058, 2018). The π₄ Prover is a deep reinforcement learning algorithm for automated theorem proving in intuitionistic propositional logic (Kusumoto M, Yahata K, and Sakai M. Automated theorem proving in intuitionistic propositional logic by deep reinforcement learning. arXiv preprint arXiv:1811.00796, 2018).

In some implementations a theorem prover computer program, evaluates symbolic logic using higher order logic. The Holophrasm is an example automated theorem proving in higher order logic that utilizes deep learning and eschewing hand-constructed features. Holophrasm exploits the formalism of the Metamath language and explores partial proof trees using a neural-network-augmented bandit algorithm and a sequence-to-sequence model for action enumeration (Whalen D. Holophrasm: a neural automated theorem prover for higher-order logic. arXiv preprint arXiv:1608.02644, 2016).

### Logical Equations

Types of logical equations are the following: 1) propositional logic (zeroth-order logic); 2) predicate logic (FOL); 3) second-order logic, extension of propositional logic; 4) higher-order logic (HOL) extends FOL with additional quantifiers and stronger semantics. The logical equations computer program takes as input a type argument that specifies the type of logic equations that will be extracted from the subnetwork 114 and/or original sentences such that the output logical proof 116 are in a form that is compatible with the selected theorem prover 203. This specification includes within the scope any combination, ensemble, or enumeration of individual types of logical equations, a mapping function that converts network relationships, word embeddings, sentences, and/or sentence fragments to the appropriate logical form and the corresponding theorem provers.

In some implementations a mapping function for propositional logic is used to map the sentence, sentence fragment, word embedding vector space, subnetwork 114, and/or word network 112 to a set of logical equations 204 that are compatible with a propositional logic theorem prover. Propositional logic encompasses propositions, statements which can be true or false, and logical connectives. An example list of logical connectives in natural language includes the following: ‘and’: ‘conjunction’, ‘or’: ‘disjunction’, ‘either..or’: ‘exclusive disjunction’, ‘implies’: ‘material implication’, ‘if and only if’: ‘biconditional’, ‘it is false that’: ‘negation’, ‘futhermore’: ‘conjunction’, and others.

The mapping function for propositional logic performs the following steps: 1) identify the logical connectives in extract sentences. 2) output sentences in the form of premises whereby the premises are taken as truths. An example is the following: Premise 1: ‘If it's snowing then it's cold.’; Premise 2: ‘If it's cold then it's not hot.’; Premise 3: ‘It is snowing.’. Thee propositional theorem prover applying an inference rule would derive the Conclusion: ‘It's cold.’. If a user typed an input query 120 using a keyboard, such that the sentence reads ‘It is hot and snowing.’ the output result 122 would return non-logical indicating that the input query does not make sense. The output result 122 would be shown to the user with a hardware display screen 121.

The top two maximum word polarity scores 115 from each subnetwork 114 is used to construct the proposition such that node and its polar node are represented when constructing a premise. Considering the previous example the node ‘hot’ and it's polar node ‘cold’ are used to construct Premise 2: ‘If it's cold then it's not hot.’. The adjacent relationships between ‘hot’, ‘cold’, ‘and’ ‘snowing’ are derived from the symmetry of the network whereby ‘cold’ in a network connects with ‘snowing’ and ‘hot’ in a network connects with ‘sunny’. The node connection of ‘cold’ connected with ‘snowing’ is how Premise 1: ‘If it's snowing then it's cold.’ is generated.

In some implementations a mapping function for second-order propositional logic can be extended such that the propositional logic premises that are defined by the mapping function contain quantification over the propositions.

In some implementations a mapping function for predicate logic is used to map the sentence, sentence fragment, word embedding vector space, subnetwork 114, and/or word network 112 to a set of logical equations 204 that are compatible with a predicate logic theorem prover. Predicate logic or FOL uses quantified variables over non-logical objects whereby sentences contain variables rather than propositions. A quantifier turns a sentence about something having some property into a sentence about a quantity having that property. FOL covers predicates and quantification whereby a predicate takes an entity or entities in the domain of discourse (e.g. logical proof 116) as input and outputs either True or False.

In some implementations a mapping function for predicate logic or FOL generates formation rules defined with the terms and formulas for FOL. A formal grammar can be defined that incorporates all formation rules. Using the top two maximum word polarity scores 115 from each subnetwork 114 formation rules can be generated beginning with a node and it's polar node. The symmetrical axes and polar word scores are used to guide the set of formation rules that are included in the grammar. The final formal grammar is the set of logical equations 203 that once validated by the predicate logic theorem are output as the logical proof 116.

In some implementations a mapping function for second order logic (SOL) is used to map the sentence, sentence fragment, word embedding vector space, subnetwork 114, and/or word network 112 to a set of logical equations 204 that are compatible with a second order logic theorem prover. In some implementations a mapping function for second order logic (SOL) generates formation rules defined with the terms and formulas for SOL. Whereas FOL quantifies only variables that range over individuals (elements of the domain of discourse), SOL quantifies over relations. SOL includes quantification over sets, functions, and other variables. An example sentence that could be represented using SOL and not FOL, ‘a is a cube and b is a cube’.

In some implementations a mapping function for higher order logic (HOL) is used to map the sentence, sentence fragment, word embedding vector space, subnetwork 114, and/or word network 112 to a set of logical equations 204 that are compatible with a higher order logic theorem prover. In some implementations a mapping function for HOL generates formation rules defined with the terms and formulas.

In the instance that a HOL could not be extracted from the sentence and/or word network and mapped into a set of higher-order logical equations a second-order logic mapper function would be used to extract from the sentence and/or word network a set of SOL equations. If a SOL is not extracted from the sentences and/or word network a first-order mapper function would be used followed by a zero-order propositional logic mapper function. If all mapper functions fail an error would be logged to an output file stored in memory.

### Operation of Word-to-Logic Extraction System

The word-to-logic extraction system in operation executes a set of computer programs residing in memory such that each computer program is passed the appropriate upstream arguments and input data sources, and upstream output residing in memory on hardware. The following computer programs residing in memory are executed as an instruction set on a processor or processors: word network builder computer program, symmetry identification computer program, word polarity computer program, theorem prover computer program, and logical equations computer program. The word-to-logic extraction system in operation takes an input peer-reviewed corpus provided by the user through a hardware interface, and outputs a logical set of symbolic equations, and the compatible theorem prover that all of which reside in memory and are executed on a processor such that a user through a hardware interface and display media can query through a hardware interface (e.g. keyboard) and obtain a result on a hardware display screen (e.g computer screen).

The word-to-logic extraction system in operation executes the computer programs in a sequential order. In operation, the word-to-logic extraction system passes the input peer-reviewed corpus residing in memory and executes word network builder computer program on instruction set on a processor 105 whereby the word network builder computer program performs the following operations: 1) extracts sentences; 2) identifies a set of words belonging to a user defined specification (e.g. equivalency words {‘is’, ‘are’, and ‘also known as’}) that represent a edge mapping and holding a relationship between two nodes; 3) identifies a set of words belonging to a user defined specification (e.g. subject and object) that represented by nodes that are connected by the previously identified edge; 4) constructs a word network 112 with nodes, edges, and a mapping ID such that the mapping ID stores the sentence used to construct the node-edge-node network; and generates the following output word network 112 that will be used as input to the symmetry identification computer program, the word polarity computer program.

An alternative embodiment the word network builder computer program is substituted for a word embedding computer program such that when the word embedding computer program residing in memory and executed by a processor produces a word embedding vector space, residing in memory on a hardware. The word embedding vector space would be used as a substitute for the word network such that the word embedding vector space residing in memory would be provided as input to the following computer programs: symmetry identification computer program,

In operation, upon the completion of the word network builder computer program, the word-to-logic extraction system passes the word network 112 residing in memory and executes symmetry identification computer program on instruction set on a processor 105 whereby the symmetry identification computer program performs the following operations: 1) identifies symmetrical axes 2) computes symmetry identification scores 3) based on symmetry identification scores defines subnetworks 114 within the word network 112 and generates the following output: symmetry identification scores 113, and subnetworks 114 that will be used as input to the word polarity computer program. This specification includes within the scope the ability to use an ensemble of symmetry identification computer programs, a selected list of symmetry identification computer programs, or an ability for the user to input a new symmetry identification computer program.

An alternative embodiment a supervised clustering computer program would execute the word-to-logic extraction system prior to the execution of symmetry identification computer program. The supervised clustering computer program residing in memory and executed by a processor would return clusters that would be used to seed the location within the word network 112. The symmetry identification computer program would only be executed on the seeded regions within the word network 112.

In operation, upon the completion of the symmetry identification computer program, the word-to-logic extraction system passes the subnetworks 114 residing in memory and the symmetry identification scores 113 residing in memory, and executes the word polarity computer program on instruction set on a processor 105 whereby the word polarity computer program performs the following operations: 1) computes a word polarity score for each node in the subnetwork in relation to every other node in the subnetwork; 2) computes the maximum word polarity scores relative to the subnetwork; 3) computes the maximum word polarity scores relative to the word network or all subnetworks; 4) returns a filtered list of subnetworks that are above a user specified word polarity threshold; and generates the following output: filtered list of subnetworks above a user specified word polarity threshold that will be used as input to the logical equations computer program.

In operation, upon the completion of the word polarity computer program, the word-to-logic extraction system passes subnetworks 114 above a user configured word polarity score 115 residing in memory, and a user specified theorem prover type or a default theorem prover type residing in memory and executes the logical equations computer program on instruction set on a processor 105 whereby the logical equations computer program performs the following operations: 1) extracts sentences that have a mapping ID that corresponds to a particular edge; 2) using the subnetwork build negation symbolic equations between the two nodes with the maximum word polarity scores within the subnetwork; 3) using the extracted sentences and/or network build logical equations that are compatible with the user specified theorem prover type or default theorem prover type. The theorem prover computer program will evaluate the logical equations generated by the logical equations computer program.

In operation, upon the completion of the logical equations computer program, the word-to-logic extraction system passes logical equations 204 residing in memory and executes the theorem prover computer program on instruction set on a processor 105 whereby the logical equations are evaluated for logical validity by the theorem prover computer program and upon receiving a Boolean value of True to indicate logical validity by the theorem prover computer program a set of logical equations are returned and used in a knowledge database and logic proof engine and delivered through a hardware interface.

### Knowledge Database

The knowledge database system 117 with the following components: input 120, hardware 102, software 118, and output 122. The input is a query such as a sentence, paragraph, and/or other content, among others. The input 120 is either typed into a computer 103 with a memory 104, processor 105 using a keyboard 119 or ‘copy & paste’ using the keyboard 119. The knowledge database 117 when queried by an individual or individuals through a hardware device executes the logic proof engine 118 software as an instruction set on a processor 105 and stores in a database that resides on a memory 104 the input query and the output value from execution of the logic proof engine 118. The output that specifies whether the input query is logical or not is returned to a user through a hardware display screen 121.

### Logic Proof Engine

The logic proof engine residing in memory and executed on a processor evaluates the input query residing in memory, the logical proof equations residing in memory and calls a theorem prover that executes the instruction set on a processor 105. An example embodiment is described using Prover9 as the automated theorem prover. Prover9, a first-order and equational logic (classic logic), uses an ASCII representation of FOL. Prover9 is given a set of assumptions, the logical proof equations, and a goal statement, the input query. Mace4 is a tool used with Prover9 that searched for finite structures satisfying first-order and equational statements. Mace4 produces statements that satisfy the input formulas (logical proof equations 116) such that the statements are interpretations and therefore models of the input formulas. Prover9 negates the goal (input query 120), transforms all assumptions (logical proof equations 116) and the goal into simpler clauses, and then attempts to find a proof by contradiction (W. McCune, “Prover9 and Mace4”, http://www.cs.unm.edu/˜mccune/ Prover9, 2005-2010.).

### Operation of Logic Proof Engine

In operation, the logic proof engine 118 passes the input query 120 residing in memory, provided by a user through a hardware device (e.g. keyboard), and the logical proof equations 116 residing in memory and executes the theorem prover computer program on instruction set on a processor 105 whereby the theorem prover computer program performs the following operations: 1) negates the goal (input query 120); 2) transforms all assumptions (logical proof equations 116) and the goal (input query 120) into simpler clauses; 3) attempts to find a proof by contradiction; and generates the following output result 122, a Boolean value that indicate whether or not the input query 120 is logical given the assumptions, logical proof equations 116. The output result 122 is returned to a user through a hardware device, a display screen 122 (e.g. tablet screen).

From the description above, a number of advantages of some embodiments of the word-to-logic system become evident:
(a) The word-to-logic system presents a generalizable solution to extracting text and turning the text into logical proofs that can be evaluated by an automated theorem prover. An aspect of the word-to-logic system is that a network of words, the symmetry of the network, the antonyms used as anchors, and the polarity of each node in the network is used to construct logical proofs whereby the words that represent each node are irrelevant to the construction of the underlying proof.
(b) The word-to-logic system is unconventional in that it represents a combination of limitations that are not well-understood, routine, or conventional activity in the field. The word-to-logic system combines limitations from independent fields of geometry and logic.
(c) An advantage of the word-to-logic system is that it is independent of content and could be applied to any specialty area and utilized in any language.
(d) An advantage of the word-to-logic system is that it scalable and can process large datasets creating significant cost savings by automating processes that have traditionally been manual.
(e) Several advantages of the word-to-logic system applied to evaluating medication prescriptions are the following: provide an automated error proof-reading system, prevent medication error, save lives, prevent future morbidities, and improvement in trust between patients and doctors.

### INDUSTRIAL APPLICABILITY

The word-to-logic system could be applied to the following use cases in the medical field:
1) A pharmacist receives an illegible written prescription from a doctor. The pharmacist scans in the prescription, and executes software to convert the scanned image to written text. The pharmacist generates a set of logical proofs using the word-to-logic extraction system trained on the national drug code standard book and the patient's medical summary. Selecting the logical proofs the pharmacist will ‘copy & paste’ the written text and modifies the word to what he believes to be the drug Lipitor before executing the knowledge database. The knowledge database returns a non-logical result. This prompts the pharmacist to hold off on the prescription and call the doctor's office. Later it is confirmed that the drug was actually Lisinopril.
2) A doctor types up a prescription in a hurry as he is being called into surgery. The prescription is automatically processed through knowledge database. The software has been pre-trained on highly peer reviewed medical text and personalized to each patient's summary of background and medication reaction history list. After surgery the doctor receives an alert from the software knowledge database that the suggested medication may be contraindicative with the patient's liver medication.
3) A nurse is handed a prescription she has a suspicion that it may contain an error. She immediately queries the software by typing the prescription with a keyboard into the text area provided by the knowledge database and then clicking the submit button. The software returns that the prescription is indeed logical. The nurse is still skeptical so she scrolls through the series of premises and conclusion that was generated by the software. Clicking on a particular premise that she was unfamiliar with the software triggers the original sentences and source of the text, which derived that relationship. She is now able to read a most recent medical journal that confirms that this particular drug is being used to treat hypertension for patients having arrhythmias. The nurse feels reassured that this is indeed the correct prescription and she continues with ordering the prescription. Later she consults with the doctor who tells her confirms the results of recent medical studies.
4) A patient is concerned that a medical prescription is incorrect. She logs into her patient portal where she is provided with an icon labeled medication error prevention. She deploys the third party app from the patient portal and enters her medical background history and medication reaction list. Using this information and peer-reviewed medical content the system trains and generates a set of logical proofs that are personalized based on the patient's data. The patient is then prompted to provide in a text area the medical prescription. Upon submitting the query the patient is alerted that medical prescription is inaccurate and a text message is automatically sent to her doctor. After 15 minutes the patient receives a call from a nurse at the doctor's office who instructs the patient to not take the prescribed medication.

Other specialty fields that could benefit from a word-to-logic system include: legal, finance, engineering, information technology, science, business, and any other field that needs logical proof checking.

1. A word-to-logic system, comprising:
one or more processors; and
one or more programs residing on a memory and executable by the one or more processors, the one or more programs configured to:
receive input text; construct a network of word relationships from the text; such that the symmetry of the network, polarity of words with respect to other words in the network is used to negate word relationship in a formal logic.
wherein the formal logic can be evaluated by an automated theorem prover to assess logical validity.

2. The system of claim 1, wherein a discourse of sentences and groups are used to construct a network.

3. The system of claim 2, wherein a word polarity score is defined between two nodes in the network whereby the nodes have symmetrical relation with respect to each other.

4. The system of claim 3, wherein the nodes share nodes.

5. The system of claim 3, wherein the nodes share antonym nodes.

6. The system of claim 1, wherein negation of polar words and their relationships is formulated as a propositional logic.

7. The system of claim 6, wherein an automated propositional logic theorem prover evaluates the propositional logic equations and returns to the user a value to indicate that the input text was logical and another value to indicate the input text was nonsensical.

8. The system of claim 1, wherein negation of polar words and their relationships is formulated as a predicate logic, first-order logic.

9. The system of claim 8, wherein an automated first-order logic theorem prover evaluates the first-order logic equations and returns to the user a value to indicate that the input text was logical and another value to indicate the input text was nonsensical.

10. The system of claim 1, wherein negation of polar words and their relationships is formulated as a second-order logic.

11. The system of claim 10, wherein an automated second-order logic theorem prover evaluates the second-order logic equations and returns to the user a value to indicate that the input text was logical and another value to indicate the input text was nonsensical.

12. The system of claim 1, wherein negation of polar words and their relationships is formulated as a higher-order logic.

13. The system of claim 12, wherein an automated higher-order logic theorem prover evaluates the higher-order logic equations and returns to the user a value to indicate that the input text was logical and another value to indicate the input text was nonsensical.

14. The system of claim 1, wherein symmetry is measured as a reflectional symmetry.

15. The system of claim 1, wherein symmetry identification is measured as a rotational symmetry.

16. The system of claim 1, wherein symmetry identification is measured as a translation symmetry.

17. The system of claim 1, wherein unsupervised clustering algorithm is used to seed the location of the word network such that the symmetry identification algorithms will only be applied to the seeded locations in the network.

18. A method for word-to-logic system, comprising the steps of:
receive input text;
construct a network of word relationships from the input text;
quantify the symmetry of the network;
negate symmetrical relationships into logical equations, wherein the logic equations can be evaluated by an automated theorem prover to assess logical validity.

19. The method of claim 18, wherein a word polarity score is defined between two nodes in the network whereby the nodes have symmetrical relation with respect to each other.

20. The method of claim 18, wherein negation of polar words and their relationships is formulated as a formal logic.

21. A word-to-logic system, comprising:
one or more processors; and
one or more programs residing on a memory and executable by the one or more processors, the one or more programs configured to:
receive an input text;
construct a word embedding vector space from the input text; such that the symmetry of the word embedding vector, polarity of word embedding vectors in the network is used to negate word relationship in a formal logic.
wherein the formal logic can be evaluated by an automated theorem prover to assess logical validity.
